(19) United States
(12) Patent Application Publication
(10) Pub. No.: US 2019/0114076 A1
(43) Pub. Date: Apr. 18, 2019

(54) Method and Apparatus for Storing Data in Distributed Block Storage System, and Computer Readable Storage Medium

(71) Applicant: Huawei Technologies Co., Ltd., Shenzhen (CN)

(72) Inventors: Mingchang Wei, Shenzhen (CN); Rong Rao, Shenzhen (CN)

(21) Appl. No.: 16/172,264

(22) Filed: Oct. 26, 2018

Related U.S. Application Data
(63) Continuation of application No. PCT/CN2017/106147, filed on Oct. 13, 2017.

(51) Int. Cl. G06F 3/06

(52) U.S. Cl. CPC G06F 3/061; G06F 3/065; G06F 3/067

(57) ABSTRACT

A method for storing data in a distributed block storage system, where a client generates data of a stripe, and concurrently sends data of strips in the stripe to storage nodes corresponding to the strips in order to reduce data exchange between the storage nodes, and improve write concurrency, thereby improving write performance of the distributed block storage system.

### CROSS-REFERENCE TO RELATED APPLICATIONS

This application is a continuation of International Patent Application No. PCT/CN2017/106147 filed on Oct. 13, 2017, which is hereby incorporated by reference in its entirety.

### TECHNICAL FIELD

The present disclosure relates to the field of information technologies, and in particular, to a method and an apparatus for storing data in a distributed block storage system, and a computer readable storage medium.

### BACKGROUND

A distributed block storage system includes a partition, the partition includes storage nodes and stripes, each stripe in the partition includes a plurality of strips, and a storage node in the partition corresponds to a strip in the stripe. That is, a storage node in the partition provides storage space to a strip in the stripe. Usually, as shown in FIG. 1, a partition includes a primary storage node (a storage node 1), and the primary storage node is configured to receive data sent by a client. Then, the primary storage node selects a stripe, divides the data into data of a strip, and sends data of a strip stored in another storage node to corresponding storage nodes (a storage node 2, a storage node 3, and a storage node 4). The foregoing operation makes the primary storage node easily become a data write bottleneck, increases data exchange between storage nodes, and degrades write performance of the distributed block storage system.

### SUMMARY

This application provides a method and an apparatus for storing data in a distributed block storage system, where a primary storage node is not required such that data exchange between storage nodes is reduced, and write performance of a distributed block storage system is improved.

A first aspect of this application provides a method for storing data in a distributed block storage system. The distributed block storage system includes a partition P, the partition P includes M storage nodes Nⱼ and R stripes Sᵢ, and each stripe includes strips SUᵢⱼ, where j is every integer from 1 to M, and i is integer from 1 to R. In the method, a first client receives a first write request, where the first write request includes first data and a logical address, the first client determines that the logical address is located in the partition P, and the first client obtains a stripe S_{N} from the R stripes included in the partition P, where N is an integer from 1 to R, and the first client divides the first data to obtain data of one or more strips SU_{Nj} in the stripe S_{N}, and sends the data of the one or more strips SU_{Nj} to a storage node Nⱼ. The client obtains stripes based on a partition, divides data into data of strips of a stripe, and sends the data of the strips to corresponding storage nodes without needing a primary storage node in order to reduce data exchange between the storage nodes, and the data of the strips of the stripe is concurrently written to the corresponding storage nodes in order to improve write performance of the distributed block storage system. Further, a physical address of a strip SUᵢⱼ in each stripe at a storage node Nⱼ may be assigned by a stripe metadata server in advance. The stripe may be a stripe generated based on an erasure coding (EC) algorithm, or may be a stripe generated based on a multi-copy algorithm. When the stripe is a stripe generated based on the EC algorithm, the strips SUᵢⱼ in the stripe include a data strip and a check strip. When the stripe is a stripe generated based on the multi-copy algorithm, all the strips SUᵢⱼ in the stripe are data strips, and the data strips have same data. Data of a data strip SU_{Nj} further includes metadata such as an identifier of the data strip SU_{Nj}, and a logical address of the data of the data strip SU_{Nj}.

With reference to the first aspect of this application, in a first possible implementation of the first aspect, the first client receives a second write request, where the second write request includes second data and the logical address, that is, the logical address of the first data is the same as the logical address of the second data, the first client determines that the logical address is located in the partition P, and the first client obtains a stripe S_{Y} from the R stripes included in the partition P, where Y is an integer from 1 to R, and N is different from Y, the first client divides the second data to obtain data of one or more strips SU_{Yj} in the stripe S_{Y}, and sends the data of the one or more strips SU_{Yj} to a storage node Nⱼ. Data of the data strip SU_{Yj} further includes metadata such as an identifier of the data strip SU_{Yj}, and a logical address of the data of the data strip SU_{Yj}.

With reference to the first aspect of this application, in a second possible implementation of the first aspect, a second client receives a third write request, where the third write request includes third data and the logical address, that is, the logical address of the first data is the same as the logical address of the third data, the second client determines that the logical address is located in the partition P, and the second client obtains a stripe S_{K} from the R stripes included in the partition P, where K is an integer from 1 to R, and N is different from K, the second client divides the third data to obtain data of one or more strips SU_{Kj} in the stripe S_{K}, and sends the data of the one or more strips SU_{Kj} to a storage node Nⱼ. Data of the data strip SU_{Kj} further includes metadata such as an identifier of the data strip SU_{Kj}, and a logical address of the data of the data strip SU_{Kj}. In the distributed block storage system, the first client and the second client may access the same logical address.

With reference to the first aspect of this application, in a third possible implementation of the first aspect, each piece of the data of the one or more strips SU_{Nj} includes at least one of an identifier of the first client and a time stamp TP_{N} at which the first client obtains the stripe S_{N}. A storage node of the distributed block storage system may determine, based on the identifier of the first client in the data of the strip SU_{Nj}, that the strip is written by the first client, and the storage node of the distributed block storage system may determine, based on the time stamp TP_{N} at which the first client obtains the stripe S_{N} and that is in the data of the strip SU_{Nj}, a sequence in which the first client writes strips.

With reference to the first possible implementation of the first aspect of this application, in a fourth possible implementation of the first aspect, each piece of the data of the one or more strips SU_{Yj} includes at least one of an identifier of the first client and a time stamp TP_{Y} at which the first client obtains the stripe S_{Y}. A storage node of the distributed block storage system may determine, based on the identifier of the first client in the data of the strip SU_{Yj}, that the strip is written by the first client, and the storage node of the distributed block storage system may determine, based on the time stamp TP_{Y} at which the first client obtains the stripe S_{Y} and that is in the data of the strip SU_{Yj}, a sequence in which the first client writes strips.

With reference to the second possible implementation of the first aspect of this application, in a fifth possible implementation of the first aspect, each piece of the data of the one or more strips SU_{Kj} includes at least one of an identifier of the second client and a time stamp TP_{K} at which the second client obtains the stripe S_{K}. A storage node of the distributed block storage system may determine, based on the identifier of the second client in the data of the strip SU_{Kj}, that the strip is written by the second client, and the storage node of the distributed block storage system may determine, based on the time stamp TP_{K} at which the first client obtains the stripe S_{K} and that is in the data of the strip SU_{Kj}, a sequence in which the second client writes strips.

With reference to the first aspect of this application, in a sixth possible implementation of the first aspect, the strip SUᵢⱼ in the stripe Sᵢ is assigned by a stripe metadata server from the storage node Nⱼ based on a mapping between the partition P and the storage node Nⱼ included in the partition. The stripe metadata server assigns a physical storage address to the strip SUᵢⱼ in the stripe Sᵢ from the storage node Nⱼ in advance, and a waiting time of a client before the client writes data may be reduced, thereby improving write performance of the distributed block storage system.

With reference to any one of the first aspect of this application or the first to the sixth possible implementations of the first aspect, in a seventh possible implementation of the first aspect, each piece of the data of the one or more strips SU_{Nj} further includes data strip status information, and the data strip status information is used to identify whether each data strip of the stripe S_{N} is empty such that it is not required that all-0 data be used to replace the data of the strip whose data is empty and be written to the storage node, thereby reducing a data write amount of the distributed block storage system.

A second aspect of this application further provides a method for storing data in a distributed block storage system. The distributed block storage system includes a partition P, the partition P includes M storage nodes Nⱼ and R stripes Sᵢ, and each stripe includes strips SUᵢⱼ, where j is every integer from 1 to M, and i is every integer from 1 to R. In the method, a storage node Nⱼ receives data of a strip SU_{Nj} in a stripe S_{N} sent by a first client, where the data of the strip SU_{Nj} is obtained by dividing first data by the first client, the first data is obtained by receiving a first write request by the first client, the first write request includes first data and a logical address, the logical address is used to determine that the first data is located in the partition P, and the storage node Nⱼ stores, based on a mapping between an identifier of the strip SU_{Nj} and a first physical address of the storage node Nⱼ, the data of SU_{Nj} at the first physical address. Because the logical address is an address at which the data written by the client is stored in the distributed block storage system, that the logical address is located in the partition P and that the first data is located in the partition P have a same meaning. The storage node Nⱼ receives only the data of the strip SU_{Nj} sent by the client. Therefore, the distributed block storage system does not need a primary storage node in order to reduce data exchange between storage nodes, and data of strips of a stripe is concurrently written to the corresponding storage nodes in order to improve write performance of the distributed block storage system. Further, a physical address of a strip SUᵢⱼ in each stripe at a storage node Nⱼ may be assigned by a stripe metadata server in advance. Therefore, the first physical address of the strip SU_{Nj} at the storage node Nⱼ is also assigned by the stripe metadata server in advance. The stripe may be a stripe generated based on an EC algorithm, or may be a stripe generated based on a multi-copy algorithm. When the stripe is a stripe generated based on the EC algorithm, the strips SUᵢⱼ in the stripe include a data strip and a check strip. When the stripe is a stripe generated based on the multi-copy algorithm, all the strips SUᵢⱼ in the stripe are data strips, and the data strips have same data. Data of a data strip SU_{Nj} further includes metadata such as an identifier of the data strip SU_{Nj}, and a logical address of the data of the data strip SU_{Nj}.

With reference to the second aspect of this application, in a first possible implementation of the second aspect, the method further includes assigning, by the storage node Nⱼ, a time stamp TP_{Nj} to the data of the strip SU_{Nj}, where the time stamp TP_{Nj} may be used as a reference time stamp at which the data of the strip in the stripe S_{N} is recovered after another storage node is faulty.

With reference to the second aspect of this application or the first possible implementation of second aspect, in a second possible implementation of the second aspect, the method further includes establishing, by the storage node Nⱼ, a correspondence between a logical address of the data of the strip SU_{Nj} and the identifier of the strip SU_{Nj} such that the client accesses, using the logical address, the data of the strip SU_{Nj} stored in the storage node Nⱼ in the distributed block storage system.

With reference to the second aspect of this application or the first or the second possible implementation of the second aspect, in a third possible implementation of the second aspect, the data of SU_{Nj} includes at least one of an identifier of the first client and a time stamp TP_{N} at which the first client obtains the stripe S_{N}. The storage node Nⱼ may determine, based on the identifier of the first client in the data of the strip SU_{Nj}, that the strip is written by the first client, and the storage node Nⱼ may determine, based on the time stamp TP_{N} at which the first client obtains the stripe S_{N} and that is in the data of the strip SU_{Nj}, a sequence in which the first client writes strips.

With reference to any one of the second aspect of this application or the first to the third possible implementations of the second aspect, in a fourth possible implementation of the second aspect, the method further includes receiving, by the storage node Nⱼ, data of a strip SU_{Yj} in a stripe S_{Y} sent by the first client, where the data of the strip SU_{Yj} is obtained by dividing second data by the first client, the second data is obtained by receiving a second write request by the first client, the second write request includes second data and the logical address, the logical address is used to determine that the second data is located in the partition P, that is, the logical address of the first data is the same as the logical address of the second data, and storing, by the storage node Nj based on a mapping between an identifier of a strip SU_{Yj} and a second physical address of the storage node Nⱼ, the data of SU_{Yj} at the second physical address. Because the logical address is an address at which the data written by the client is stored in the distributed block storage system, that the logical address is located in the partition P and that the second data is located in the partition P have a same meaning. Data of a data strip SU_{Yj} further includes metadata such as an identifier of the data strip SU_{Yj}, and a logical address of the data of the data strip SU_{Yj}.

With reference to the fourth possible implementation of the second aspect of this application, in a fifth possible implementation of the second aspect, the method further includes assigning, by the storage node Nⱼ, a time stamp TP_{Yj} to the data of the strip SU_{Yj}. The time stamp TP_{Yj} may be used as a reference time stamp at which the data of the strip in the stripe S_{Y} is recovered after another storage node is faulty.

With reference to the fourth or the fifth possible implementation of the second aspect of this application, in a sixth possible implementation of the second aspect, the method further includes establishing, by the storage node Nⱼ, a correspondence between a logical address of the data of the strip SU_{Yj} and an identifier of the strip SU_{Yj} such that the client accesses, using the logical address, the data of the strip SU_{Yj} stored in the storage node Nⱼ in the distributed block storage system.

With reference to any one of the fourth to the sixth possible implementations of the second aspect of this application, in a seventh possible implementation of the second aspect, the data of SU_{Yj} includes at least one of the identifier of the first client and a time stamp TP_{Y} at which the first client obtains the stripe S_{Y}. The storage node Nⱼ may determine, based on the identifier of the first client in the data of the strip SU_{Yj}, that the strip is written by the first client, and the storage node Nⱼ may determine, based on the time stamp TP_{Y} at which the first client obtains the stripe S_{Y} and that is in the data of the strip SU_{Yj}, a sequence in which the first client writes strips.

With reference to the second aspect of this application or the first or the second possible implementation of the second aspect, in an eighth possible implementation of the second aspect, the method further includes receiving, by the storage node Nⱼ, data of a strip SU_{Kj} in a stripe S_{K} sent by a second client, where the data of the strip SU_{Kj} is obtained by dividing third data by the second client, the third data is obtained by receiving a third write request by the second client, the third write request includes the third data and the logical address, the logical address is used to determine that the third data is located in the partition P, that is, the logical address of the first data is the same as the logical address of the third data, and storing, by the storage node Nj based on a mapping between an identifier of a strip SU_{Kj} and a third physical address of the storage node Nⱼ, the data of SU_{Kj} at the third physical address. Because the logical address is an address at which the data written by the client is stored in the distributed block storage system, that the logical address is located in the partition P and that the third data is located in the partition P have a same meaning. In the distributed block storage system, the first client and the second client may access the same logical address. Data of a data strip SU_{Kj} further includes metadata such as an identifier of the data strip SU_{Kj}, and a logical address of the data of the data strip SU_{Kj}.

With reference to the eighth possible implementation of the second aspect, in a ninth possible implementation of the second aspect, the method further includes assigning, by the storage node Nⱼ, a time stamp TP_{Kj} to the data of the strip SU_{Kj}. The time stamp TP_{Kj} may be used as a reference time stamp at which the data of the strip in the stripe S_{K} is recovered after another storage node is faulty.

With reference to the eighth or the ninth possible implementation of the second aspect of this application, in a tenth possible implementation of the second aspect, the method further includes establishing, by the storage node Nⱼ, a correspondence between a logical address of the data of the strip SU_{Kj} and an identifier of the strip SU_{Kj} such that the client accesses, using the logical address, the data of the strip SU_{Kj} stored in the storage node Nⱼ in the distributed block storage system.

With reference to any one of the eighth to the tenth possible implementations of the second aspect of this application, in an eleventh possible implementation of the second aspect, the data of SU_{Kj} includes at least one of an identifier of the second client and a time stamp TP_{K} at which the second client obtains the stripe S_{K}. The storage node Nⱼ may determine, based on the identifier of the second client in the data of the strip SU_{Kj}, that the strip is written by the second client, and the storage node Nⱼ may determine, based on the time stamp TP_{K} at which the second client obtains the stripe S_{K} and that is in the data of the strip SU_{Kj}, a sequence in which the second client writes strips.

With reference to the second aspect of this application, in a twelfth possible implementation of the second aspect, the strip SUᵢⱼ in the stripe Sᵢ is assigned by a stripe metadata server from the storage node Nⱼ based on a mapping between the partition P and the storage node Nⱼ included in the partition P. The stripe metadata server assigns a physical storage address to the strip SUᵢⱼ in the stripe Sᵢ from the storage node Nⱼ in advance, and a waiting time of a client before the client writes data may be reduced, thereby improving write performance of the distributed block storage system.

With reference to any one of the second aspect of this application or the first to the twelfth possible implementations of the second aspect, in a thirteenth possible implementation of the second aspect, each piece of data of the one or more strips SU_{Nj} further includes data strip status information, and the data strip status information is used to identify whether each data strip of the stripe S_{N} is empty such that it is not required that all-0 data be used to replace the data of the strip whose data is empty and be written to the storage node, thereby reducing a data write amount of the distributed block storage system.

With reference to the ninth possible implementation of the second aspect, in a fourteenth possible implementation of the second aspect, after the storage node Nⱼ is faulty, a new storage node recovers the data of the strip SU_{Nj} and the data of SU_{Kj} based on the stripe S_{N} and the stripe S_{K} respectively, the new storage node obtains a time stamp TP_{NX} of data of a strip SU_{NX} in a storage node N_{X} as a reference time stamp of the data of the strip SU_{Nj}, and obtains a time stamp TP_{KX} of data of a strip SU_{KX} in the storage node N_{X} as a reference time stamp of the data of the strip SU_{Kj}, and the new storage node eliminates, from a buffer based on the time stamp TP_{NX} and the time stamp TP_{KX}, strip data, corresponding to an earlier time, in the data of the strip SU_{Nj} and the data of SU_{Kj}, where X is any integer from 1 to M other than j. Latest strip data is reserved in the storage system, thereby saving buffer space.

With reference to the seventh possible implementation of the second aspect, in a fifteenth possible implementation of the second aspect, after the storage node Nⱼ is faulty, a new storage node recovers the data of the strip SU_{Nj} and the data of SU_{Yj} based on the stripe S_{N} and the stripe S_{Y} respectively, where the data of the strip SU_{NX} includes the time stamp TP_{N}, and the data of the strip SU_{Yj} includes the time stamp TP_{Y}, and the new storage node eliminates, from a buffer based on the time stamp TP_{N} and the time stamp TP_{Y}, the earlier one of the data of the strip SU_{Nj} and the data of SU_{Yj}, where X is any integer from 1 to M other than j. Latest strip data of the same client is reserved in the storage system, thereby saving buffer space.

With reference to the distributed block storage system in any one of the first aspect of this application or the first to the seventh possible implementations of the first aspect, a third aspect of this application further provides an apparatus for writing data in a distributed block storage system. The apparatus for writing data includes a plurality of units configured to perform any one of the first aspect of this application or the first to the seventh possible implementations of the first aspect.

With reference to the distributed block storage system in any one of the second aspect of this application or the first to the fifteenth possible implementations of the second aspect, a fourth aspect of this application further provides an apparatus for storing data in a distributed block storage system. The apparatus for storing data includes a plurality of units configured to perform any one of the second aspect of this application or the first to the fifteenth possible implementations of the second aspect.

A fifth aspect of this application further provides the distributed block storage system in any one of the second aspect of this application or the first to the fifteenth possible implementations of the second aspect. A storage node Nⱼ in the distributed block storage system is configured to perform any one of the second aspect of this application or the first to the fifteenth possible implementations of the second aspect.

A sixth aspect of this application further provides a client, applied to the distributed block storage system in any one of the first aspect of this application or the first to the seventh possible implementations of the first aspect. The client includes a processor and an interface, the processor communicates with the interface, and the processor is configured to perform any one of the first aspect of this application or the first to the seventh possible implementations of the first aspect.

A seventh aspect of this application further provides a storage node, applied to the distributed block storage system in any one of the second aspect of this application or the first to the fifteenth possible implementations of the second aspect. The storage node used as a storage node Nⱼ includes a processor and an interface, the processor communicates with the interface, and the processor is configured to perform any one of the second aspect of this application or the first to the fifteenth possible implementations of the second aspect.

An eighth aspect of this application further provides a computer readable storage medium, applied to the distributed block storage system in any one of the first aspect of this application or the first to the seventh possible implementations of the first aspect. The computer readable storage medium includes a computer instruction, used to enable a client to perform any one of the first aspect of this application or the first to the seventh possible implementations of the first aspect.

A ninth aspect of this application further provides a computer readable storage medium, applied to the distributed block storage system in any one of the second aspect of this application or the first to the fifteenth possible implementations of the second aspect. The computer readable storage medium includes a computer instruction, used to enable a storage node to perform any one of the second aspect of this application or the first to the fifteenth possible implementations of the second aspect.

A tenth aspect of this application further provides a computer program product, applied to the distributed block storage system in any one of the first aspect of this application or the first to the seventh possible implementations of the first aspect. The computer program product includes a computer instruction, used to enable a client to perform any one of the first aspect of this application or the first to the seventh possible implementations of the first aspect.

An eleventh aspect of this application further provides a computer program product, applied to the distributed block storage system in any one of the second aspect of this application or the first to the fifteenth possible implementations of the second aspect. The computer program product includes a computer instruction, used to enable a storage node to perform any one of the second aspect of this application or the first to the fifteenth possible implementations of the second aspect.

### BRIEF DESCRIPTION OF DRAWINGS

FIG. 1 is a schematic diagram of data storage of a distributed block storage system;

FIG. 2 is a schematic diagram of a distributed block storage system according to an embodiment of the present disclosure;

FIG. 3 is a schematic structural diagram of a server in a distributed block storage system according to an embodiment of the present disclosure;

FIG. 4 is a schematic diagram of a partition view of a distributed block storage system according to an embodiment of the present disclosure;

FIG. 5 is a schematic diagram of a relationship between strips and storage nodes in a distributed block storage system according to an embodiment of the present disclosure;

FIG. 6 is a flowchart of a method for writing data by a client in a distributed block storage system according to an embodiment of the present disclosure;

FIG. 7 is a schematic diagram of determining a partition by a client in a distributed block storage system according to an embodiment of the present disclosure;

FIG. 8 is a flowchart of a method for storing data in a storage node in a distributed block storage system according to an embodiment of the present disclosure;

FIG. 9 is a schematic diagram of storing a stripe in a storage node in a distributed block storage system according to an embodiment of the present disclosure;

FIG. 10 is a schematic diagram of storing a stripe in a storage node in a distributed block storage system according to an embodiment of the present disclosure;

FIG. 11 is a schematic structural diagram of an apparatus for writing data in a distributed block storage system according to an embodiment of the present disclosure; and

FIG. 12 is a schematic structural diagram of an apparatus for storing data in a distributed block storage system according to an embodiment of the present disclosure.

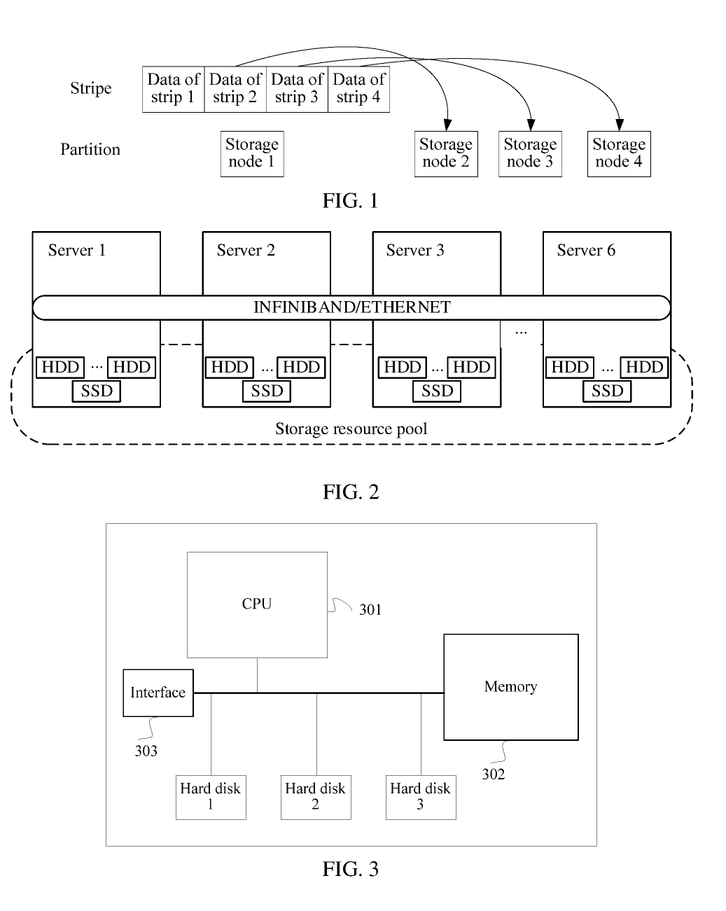

### DESCRIPTION OF EMBODIMENTS

A distributed block storage system in the embodiments of the present disclosure is, for example, Huawei® Fusionstorage® series. For example, as shown in FIG. 2, a distributed block storage system includes a plurality of servers such as a server 1, a server 2, a server 3, a server 4, a server 5, and a server 6, and the servers communicate with each other using the INFINIBAND, the ETHERNET, or the like. In actual application, a quantity of servers in the distributed block storage system may be increased based on an actual requirement. This is not limited in the embodiments of the present disclosure.

A server of the distributed block storage system includes a structure shown in FIG. 3. As shown in FIG. 3, each server in the distributed block storage system includes a central processing unit (CPU) 301, a memory 302, an interface 303, a hard disk 1, a hard disk 2, and a hard disk 3, the memory 302 stores a computer instruction, and the CPU 301 executes the computer instruction in the memory 302 to perform a corresponding operation. The interface 303 may be a hardware interface such as a network interface card (NIC) or a host bus adapter (HBA), or may be a program interface module or the like. A hard disk includes a solid-state drive (SSD), a mechanical hard disk, or a hybrid hard disk. The mechanical hard disk is, for example, a Hard Disk Drive (HDD). Additionally, to save computing resources of the CPU 301, a field programmable gate array (FPGA) or other hardware may replace the CPU 301 to perform the foregoing corresponding operation, or an FPGA or other hardware and the CPU 301 jointly perform the foregoing corresponding operation. For convenience of description, in the embodiments of the present disclosure, a combination of the CPU 301, the memory 302, the FPGA, and the other hardware replacing the CPU 301 or a combination of the FPGA, the other hardware replacing the CPU 301, and the CPU 301 is collectively referred to as a processor.

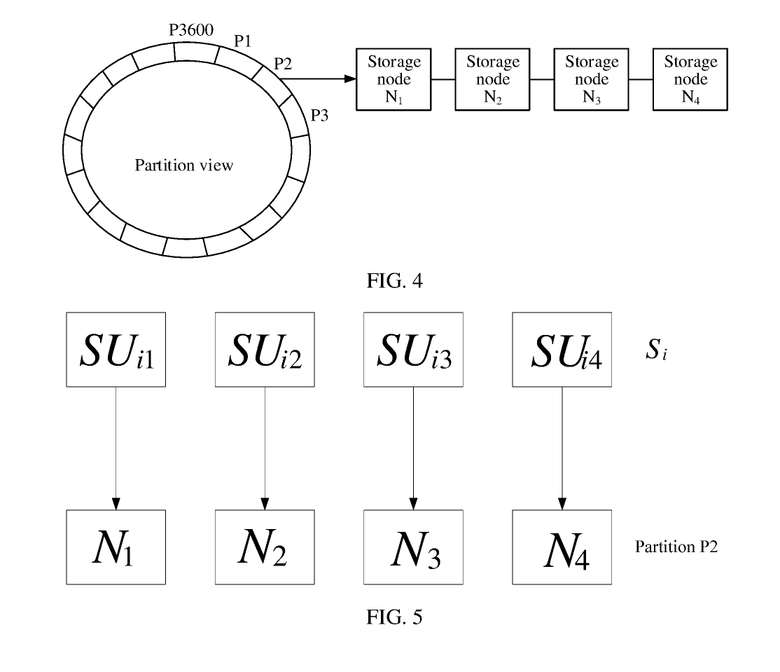

In the structure shown in FIG. 3, an application program is loaded into the memory 302, the CPU 301 executes an instruction of the application program in the memory 302, and the server is used as a client. Additionally, the client may be a device independent of the servers shown in FIG. 2. The application program may be a virtual machine (VM), or may be a particular application such as office software. The client writes data to the distributed block storage system or reads data from the distributed block storage system. For a structure of the client, refer to FIG. 3 and a related description. A program of the distributed block storage system is loaded into the memory 302, and the CPU 301 executes the program of the distributed block storage system in the memory 302 to provide a block protocol access interface to the client, and provide a distributed block storage access point service to the client such that the client accesses a storage resource in a storage resource pool in the distributed block storage system. The block protocol access interface is configured to provide a logical unit to the client. The server runs the program of the distributed block storage system such that the server that includes the hard disks and that is used as a storage node is configured to store data of the client. For example, in the server, one hard disk may be used as one storage node by default. That is, when the server includes a plurality of hard disks, the plurality of hard disks may be used as a plurality of storage nodes. In another implementation, the server runs the program of the distributed block storage system to serve as one storage node. This is not limited in the embodiments of the present disclosure. Therefore, for a structure of a storage node, refer to FIG. 3 and a related description. When the distributed block storage system is initialized, Hash space (such as 0 to 2̂32) is divided into N equal portions, each equal portion is one partition, and these N equal portions are averaged based on a quantity of hard disks. For example, in the distributed block storage system, N is 3600 by default, that is, partitions are P1, P2, P3, . . . , and P3600, respectively. If the current distributed block storage system includes 18 hard disks (storage nodes), each storage node bears 200 partitions. A partition P includes M storage nodes Nⱼ, and a correspondence between a partition and a storage node, that is, a mapping between a partition and a storage node Nⱼ included in the partition is also referred to as a partition view. As shown in FIG. 4, an example in which a partition includes four storage nodes Nⱼ is used, and a partition view is “P2—storage node N₁—storage node N₂—storage node N₃—storage node N₄”, where j is every integer from 1 to M. When the distributed block storage system is initialized, the storage nodes are assigned. Subsequently, as a quantity of hard disks in the distributed block storage system changes, the storage nodes are adjusted. The client stores the partition view.

Based on a reliability requirement of the distributed block storage system, data reliability can be improved using an EC algorithm such as using a 3+1 mode, that is, a stripe includes three data strips and one check strip. In the embodiments of the present disclosure, a partition stores data in a stripe form, and one partition includes R stripes Sᵢ, where i is every integer from 1 to R. In the embodiments of the present disclosure, P2 is used as an example for description.

The distributed block storage system performs fragment management on a hard disk using 4 kilobytes (KB) as a unit, and records assignment information of each fragment of 4 KB in a metadata management area of the hard disk, and a storage resource pool includes fragments of the hard disk. The distributed block storage system includes a stripe metadata server, and in a specific implementation, a stripe metadata management program may be run on one or more servers in the distributed block storage system. The stripe metadata server assigns a stripe to a partition. Still using the partition view shown in FIG. 4 as an example, the stripe metadata server assigns, to a stripe Sᵢ of a partition P2 based on the partition view and as shown in FIG. 5, a physical storage address, that is, storage space, of a strip SUᵢⱼ in the stripe from a storage node Nⱼ corresponding to the partition, and assigning includes assigning a physical storage address to SUᵢ₁ from a storage node N₁, assigning a physical storage address to SUᵢ₂ from a storage node N₂, assigning a physical storage address to SUᵢ₃ from a storage node N₃, and assigning a physical storage address to SUᵢ₄ from a storage node N₄. The storage node Nⱼ records a mapping between an identifier of a strip SUᵢⱼ and a physical storage address. The stripe metadata server assigns a physical address to a strip in a stripe from a storage node, and the physical address may be assigned in advance when the distributed block storage system is initialized, or be assigned in advance before the client sends data to the storage node. In the embodiments of the present disclosure, the strip SUᵢⱼ in the stripe Sᵢ is only a segment of storage space before the client writes data. When receiving data, the client performs division based on a size of the strip SUᵢⱼ in the stripe Sᵢ to obtain data of the strip SUᵢⱼ, that is, the strip SUᵢⱼ included in the stripe Sᵢ is used to store the data of the strip SUᵢⱼ obtained by dividing data by the client. To reduce a quantity of strip identifiers managed by the stripe metadata server, the stripe metadata server assigns a version number to an identifier of a strip in a stripe. After a stripe is released, a version number of a strip identifier of a strip in the released stripe is updated in order to serve as a strip identifier of a strip in a new stripe. The stripe metadata server assigns a physical storage address to the strip SUᵢⱼ in the stripe Sᵢ from the storage node Nⱼ in advance, and a waiting time of a client before the client writes data may be reduced, thereby improving write performance of the distributed block storage system.

In the embodiments of the present disclosure, a logical unit assigned by the distributed block storage system is mounted to the client, thereby performing a data access operation. The logical unit is also referred to as a logical unit number (LUN). In the distributed block storage system, one logical unit may be mounted to only one client, or one logical unit may be mounted to a plurality of clients, that is, a plurality of clients share one logical unit. The logical unit is provided by the storage resource pool shown in FIG. 2.

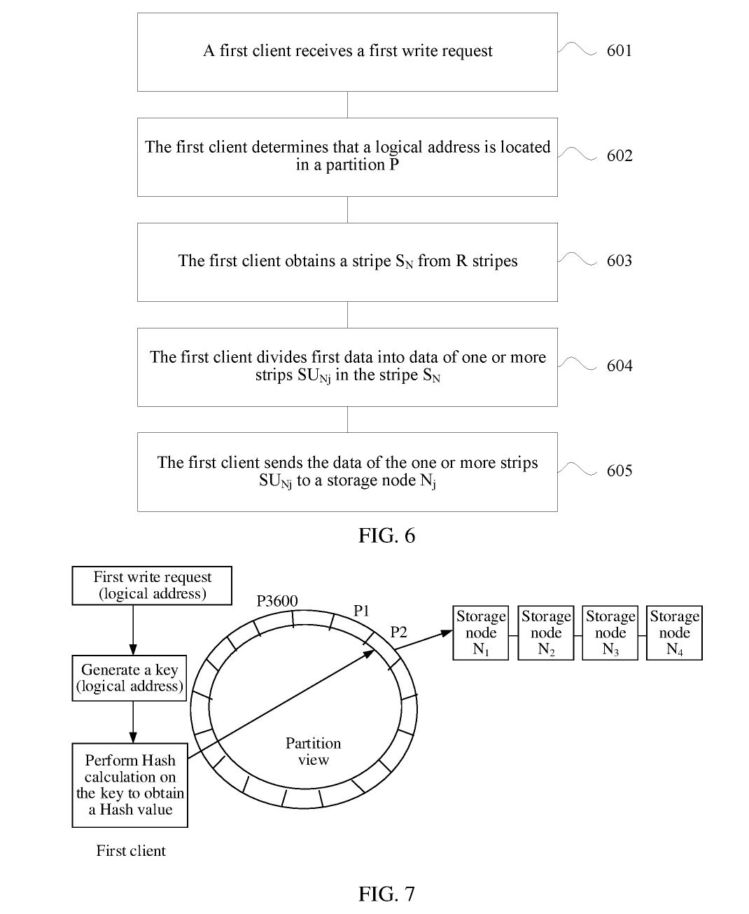

In an embodiment of the present disclosure, as shown in FIG. 6, a first client performs the following steps.

Step 601: The first client receives a first write request, where the first write request includes first data and a logical address.

In a distributed block storage system, the first client may be a VM or a server. An application program is run on the first client, and the application program accesses a logical unit mounted to the first client, for example, sends the first write request to the logical unit. The first write request includes the first data and the logical address, and the logical address is also referred to as a logical block address (LBA). The logical address is used to indicate a write location of the first data in the logical unit.

Step 602: The first client determines that the logical address is located in a partition P.

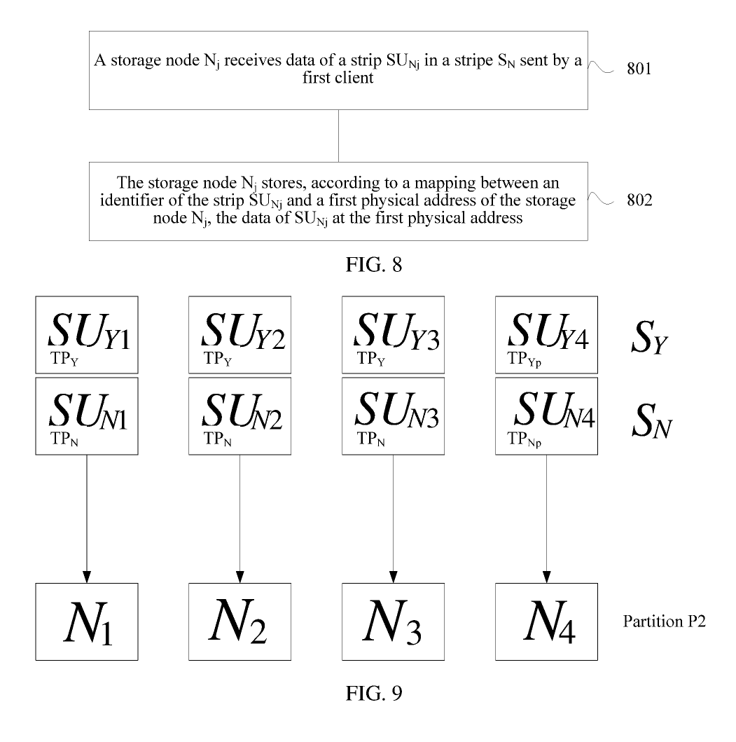

In this embodiment of the present disclosure, a partition P2 is used as an example. With reference to FIG. 4, the first client stores a partition view of the distributed block storage system. As shown in FIG. 7, the first client determines, based on the partition view, a partition in which the logical address included in the first write request is located. In an implementation, the first client generates a key based on the logical address, calculates a Hash value of the key based on a Hash algorithm, and determines a partition corresponding to the Hash value, thereby determining that the logical address is located in the partition P2. This also means that the first data is located in the partition P2.

Step 603: The first client obtains a stripe S_{N} from R stripes, where N is an integer from 1 to R.

A stripe metadata server manages a correspondence between a partition and a stripe, and a relationship between a strip in a stripe and a storage node. In an implementation in which the first client obtains a stripe S_{N} from R stripes, the first client determines that the logical address is located in the partition P2, and the first client queries the stripe metadata server to obtain a stripe S_{N} of the R stripes included in the partition P2. Because the logical address is an address at which the data written by the client is stored in the distributed block storage system, that the logical address is located in the partition P and that the first data is located in the partition P have a same meaning. In another implementation in which the first client obtains a stripe S_{N} from R stripes, the first client may obtain a stripe S_{N} from stripes that are assigned to the first client and that are of the R stripes.

Step 604: The first client divides the first data into data of one or more strips SU_{Nj} in the stripe S_{N}.

The stripe S_{N} includes strips, and the first client receives the first write request, buffers the first data included in the first write request, and divides the buffered data based on a size of a strip in the stripe. For example, the first client performs division based on a length of the strip in the stripe to obtain strip size data, and performs a modulo operation on a quantity M (such as four) of storage nodes in the partition based on a logical address of the strip size data, thereby determining a location of the strip size data in the stripe, that is, a corresponding strip SU_{Nj}, and then determines a storage node Nⱼ corresponding to the strip SU_{Nj} based on the partition view such that data of strips having a same logical address is located in a same storage node. For example, the first data is divided into data of one or more strips SU_{Nj}. In this embodiment of the present disclosure, P2 is used as an example. With reference to FIG. 5, the stripe S_{N} includes four strips SU_{N1}, SU_{N2}, SU_{N3}, and SU_{N4}. An example in which the first data is divided into data of two strips is used, that is, the data of two strips is data of SU_{N1} and data of SU_{N2}. Data of the strip SU_{N3} may be obtained by dividing data in another write request sent by the first client. For details, refer to the description of the first write request. Then, data of the check strip SU_{N4} is generated based on the data of SU_{N1}, the data of SU_{N2}, and the data of SU_{N3}, and the data of the check strip SU_{N4} is also referred to as check data. For how to generate the data of the check strip based on the data of the data strips in the stripe, refer to an existing stripe implementation algorithm. Details are not described again in this embodiment of the present disclosure.

In this embodiment of the present disclosure, the stripe S_{N} includes four strips, that is, three data strips and one check strip. When the first client buffers data and needs to write the data to a storage node after a period of time, but cannot make data of the data strips full, for example, there are only the data of the strip SU_{N1} and the data of SU_{N2} obtained by dividing the first data, the check strip is generated based on the data of SU_{N1} and the data of SU_{N2}. Data of a valid data strip SU_{Nj} includes data strip status information of the stripe S_{N}, and the valid data strip SU_{Nj} is a strip whose data is not empty. In this embodiment of the present disclosure, both the data of the valid data strip SU_{N1} and the data of SU_{N2} include the data strip status information of the stripe S_{N}, and the data strip status information is used to identify whether each data strip of the stripe S_{N} is empty. For example, if 1 is used to indicate that a data strip is not empty, and 0 is used to indicate that a data strip is empty, the data strip status information included in the data of SU_{N1} is 110, and the data strip status information included in the data of SU_{N2} is 110, indicating that SU_{N1} is not empty, SU_{N2} is not empty, and SU_{N3} is empty. The data of the check strip SU_{N4} generated based on the data of SU_{N1} and the data of SU_{N2} includes check data of the data strip status information. Because SU_{N3} is empty, the first client does not need to replace the data of SU_{N3} with all-0 data and write the all-0 data to a storage node N₃, thereby reducing a data write amount. When reading the stripe S_{N}, the first client determines, based on the data strip status information of the stripe S_{N} included in the data of the data strip SU_{N1} or the data of SU_{N2}, that the data of SU_{N3} is empty.

When SU_{N3} is not empty, the data strip status information included in the data of SU_{N1}, the data of SU_{N2}, and the data of SU_{N3} in this embodiment of the present disclosure is 111, and the data of the check strip SU_{N4} generated based on the data of SU_{N1}, the data of SU_{N2}, and the data of SU_{N3} includes check data of the data strip status information.

Further, in this embodiment of the present disclosure, the data of the data strip SU_{Nj} further includes at least one of an identifier of the first client and a time stamp TP_{N} at which the first client obtains the stripe S_{N}, that is, includes any one of or a combination of the identifier of the first client and the time stamp TP_{N} at which the first client obtains the stripe S_{N}. When data of a check strip SU_{Nj} is generated based on the data of the data strip SU_{Nj}, the data of the check strip SU_{Nj} also includes check data of at least one of the identifier of the first client and the time stamp TP_{N} at which the first client obtains the stripe S_{N}.

In this embodiment of the present disclosure, the data of the data strip SU_{Nj} further includes metadata such as an identifier of the data strip SU_{Nj}, and a logical address of the data of the data strip SU_{Nj}.

Step 605: The first client sends the data of the one or more strips SU_{Nj} to a storage node Nⱼ.

In this embodiment of the present disclosure, the first client sends the data of SU_{N1} obtained by dividing the first data to the storage node N₁, and sends the data of SU_{N2} obtained by dividing the first data to the storage node N₂. The first client may concurrently send the data of the strip SU_{Nj} of the stripe S_{N} to the storage node Nⱼ without needing a primary storage node in order to reduce data exchange between the storage nodes, and improve write concurrency, thereby improving write performance of the distributed block storage system.

Further, if a logical unit is mounted to only the first client, the first client receives a second write request, where the second write request includes second data and the logical address that is described in FIG. 6, the first client determines, based on the algorithm described in the process in FIG. 6, that the logical address is located in the partition P2, the first client obtains a stripe S_{Y} from the R stripes, the first client divides the second data into data of one or more strips SU_{Yj} in the stripe S_{Y}, such as data of SU_{Y1} and data of SU_{Y2}, and the first client sends the data of the one or more strips SU_{Yj} to the storage node Nⱼ, that is, sends the data of SU_{Y1} to the storage node N₁, and sends the data of SU_{Y2} to the storage node N₂, where Y is an integer from 1 to R, and N is different from Y. In this embodiment of the present disclosure, that the logical address is located in the partition P and that the second data is located in the partition P have a same meaning. Further, data of a valid data strip SU_{Yj} includes data strip status information of the stripe S_{Y}. Further, the data of the data strip SU_{Yj} further includes at least one of an identifier of the first client and a time stamp TP_{Y} at which the first client obtains the stripe S_{Y}. Further, the data of the data strip SU_{Yj} further includes metadata of the data of the data strip SU_{Yj}, such as an identifier of the strip SU_{Yj}, and a logical address of the data of the strip SU_{Yj}. For a further description, refer to the description of the first client in FIG. 6. Details are not described herein again. For obtaining, by the first client, the stripe S_{Y} from the R stripes, refer to obtaining, by the first client, the stripe S_{N} from the R stripes. Details are not described herein again.

Further, if a logical unit is mounted to a plurality of clients, for example, mounted to the first client and a second client, the second client receives a third write request, where the third write request includes third data and the logical address that is described in FIG. 6. The second client determines, based on the algorithm described in the process in FIG. 6, that the logical address is located in the partition P2, the second client obtains a stripe S_{K} from the R stripes, the second client divides the third data into data of one or more strips SU_{Kj} in the stripe S_{K}, such as data of SU_{K1} and data of SU_{K2}, and the second client sends the data of the one or more strips SU_{Kj} to the storage node Nⱼ, that is, sends the data of SU_{K1} to the storage node N₁, and sends the data of SU_{K2} to the storage node N₂, where K is an integer from 1 to R, and N is different from K. That the logical address is located in the partition P and that the third data is located in the partition P have a same meaning. For the meaning of obtaining, by the second client, the stripe S_{K} from the R stripes, refer to the meaning of obtaining, by the first client, the stripe S_{N} from the R stripes. Details are not described herein again. Further, data of a valid data strip SU_{Kj} includes data strip status information of the stripe S_{K}. Further, the data of the data strip SU_{Kj} further includes at least one of an identifier of the second client and a time stamp TP_{K} at which the second client obtains the stripe S_{K}. Further, the data of the data strip SU_{Kj} further includes metadata such as an identifier of the data strip SU_{Kj}, and a logical address of the data of the data strip SU_{Kj}. For a further description of the second client, refer to the description of the first client in FIG. 6. Details are not described herein again.

In other approaches, a client needs to first send data to a primary storage node, and the primary storage node divides the data into data of strips, and sends data of strips other than a strip stored in the primary storage node to corresponding storage nodes. As a result, the primary storage node becomes a data storage bottleneck in a distributed block storage system, and data exchange between the storage nodes is increased. However, in the embodiment shown in FIG. 6, the client divides the data into the data of the strips, and sends the data of the strips to the corresponding storage nodes without needing a primary storage node in order to alleviate a pressure of the primary storage node, reduce data exchange between the storage nodes, and the data of the strips of the stripe is concurrently written to the corresponding storage nodes in order to also improve write performance of the distributed block storage system.

Corresponding to the embodiment of the first client shown in FIG. 6, as shown in FIG. 8, a storage node Nⱼ performs the following steps.

Step 801: The storage node Nⱼ receives data of a strip SU_{Nj} in a stripe S_{N} sent by a first client.

With reference to the embodiment shown in FIG. 6, a storage node N₁ receives data of SU_{N1} sent by the first client, and a storage node N₂ receives data of SU_{N2} sent by the first client.

Step 802: The storage node Nⱼ stores, based on a mapping between an identifier of the strip SU_{Nj} and a first physical address of the storage node Nⱼ, the data of SU_{Nj} at the first physical address.

A stripe metadata server assigns, in the storage node Nⱼ, the first physical address to the strip SU_{Nj} of the stripe S_{N} in a partition in advance based on a partition view, metadata of the storage node Nⱼ stores the mapping between the identifier of the strip SU_{Nj} and the first physical address of the storage node Nⱼ, and the storage node Nⱼ receives the data of the strip SU_{Nj}, and stores the data of the strip SU_{Nj} at the first physical address based on the mapping. For example, the storage node N₁ receives the data of SU_{N1} sent by the first client, and stores the data of SU_{N1} at the first physical address of N₁, and the storage node N₂ receives the data of SU_{N2} sent by the first client, and stores the data of SU_{N2} at the first physical address of N₂.

In the other approaches, a primary storage node needs data sent by a client, divides the data into data of data strips in a stripe, forms data of a check strip based on the data of the data strips, and sends data of strips stored in other storage nodes to corresponding storage nodes. However, in this embodiment of the present disclosure, the storage node Nⱼ receives only the data of the strip SU_{Nj} sent by the client without needing a primary storage node in order to reduce data exchange between storage nodes, and data of strips is concurrently written to the corresponding storage nodes in order to improve write performance of a distributed block storage system.

Further, the data of the strip SU_{Nj} is obtained by dividing first data, a first write request includes a logical address of the first data, and the data of the strip SU_{Nj} used as a part of the first data also has a corresponding logical address. Therefore, the storage node Nⱼ establishes a mapping between the logical address of the data of the strip SU_{Nj} and the identifier of the strip SU_{Nj}. In this way, the first client still accesses the data of the strip SU_{Nj} using the logical address. For example, when the first client accesses the data of the strip SU_{Nj}, the first client performs a modulo operation on a quantity M (such as four) of storage nodes in a partition P using the logical address of the data of the strip SU_{Nj}, determines that the strip SU_{Nj} is located in the storage node Nⱼ, and sends a read request carrying the logical address of the data of the strip SU_{Nj} to the storage node Nⱼ, the storage node Nⱼ obtains the identifier of the strip SU_{Nj} based on the mapping between the logical address of the data of the strip SU_{Nj} and the identifier of the strip SU_{Nj}, and the storage node Nⱼ obtains the data of the strip SU_{Nj} based on the mapping between the identifier of the strip SU_{Nj} and the first physical address of the storage node Nⱼ.

With reference to the embodiment shown in FIG. 6 and the related description, further, the storage node Nⱼ receives data of a strip SU_{Yj} in a stripe S_{Y} sent by the first client. For example, the storage node N₁ receives data of SU_{Y1} sent by the first client, and the storage node N₂ receives data of SU_{Y2} sent by the first client. The storage node Nⱼ stores, based on a mapping between an identifier of the strip SU_{Yj} and a second physical address of the storage node Nⱼ, the data of SU_{Yj} at the second physical address, for example, stores the data of SU_{Y1} at a second physical address of N₁, and stores the data of SU_{Y2} at a second physical address of N₂. The data of the strip SU_{Yj} used as a part of second data also has a corresponding logical address, and therefore, the storage node Nⱼ establishes a mapping between the logical address of the data of the strip SU_{Yj} and the identifier of the strip SU_{Yj}. In this way, the first client still accesses the data of the strip SU_{Y} using the logical address. The data of the strip SU_{Yj} and the data of the strip SU_{Nj} have the same logical address.

With reference to the embodiment shown in FIG. 6 and the related description, when a logical unit is mounted to the first client and the second client, further, the storage node Nⱼ receives data of a strip SU_{Kj} in a stripe S_{K} sent by the second client. For example, the storage node N₁ receives data of SU_{K1} sent by the second client, and the storage node N₂ receives data of SU_{K2} sent by the second client. The storage node Nⱼ stores, based on a mapping between an identifier of the strip SU_{Kj} and a third physical address of the storage node Nⱼ, the data of SU_{Kj} at the third physical address, for example, stores the data of SU_{K1} at a third physical address of N₁, and stores the data of SU_{K2} at a third physical address of N₂. The data of the strip SU_{Kj} used as a part of third data also has a corresponding logical address, and therefore, the storage node Nⱼ establishes a mapping between the logical address of the data of the strip SU_{Kj} and the identifier of the strip SU_{Kj}. In this way, the second client still accesses the data of the strip SU_{Kj} using the logical address. The data of the strip SU_{Kj} and the data of the strip SU_{Nj} have the same logical address.

Further, the storage node Nⱼ assigns a time stamp TP_{Nj} to the data of the strip SU_{Nj}, the storage node Nⱼ assigns a time stamp TP_{Kj} to the data of the strip SU_{Kj}, and the storage node Nⱼ assigns a time stamp TP_{Yj} to the data of the strip SU_{Yj}. The storage node Nⱼ may eliminate, based on the time stamps, strip data, corresponding to an earlier time, in strip data that has a same logical address in a buffer, and reserve latest strip data, thereby saving buffer space.

With reference to the embodiment shown in FIG. 6 and the related description, when a logical unit is mounted to only the first client, the data of the strip SU_{Nj} sent by the first client to the storage node Nⱼ includes the time stamp TP_{N} at which the first client obtains the stripe S_{N}, and the data of the strip SU_{Yj} sent by the first client to the storage node Nⱼ includes the time stamp TP_{Y} at which the first client obtains the stripe S_{Y}. As shown in FIG. 9, none of data strips of a stripe S_{N} is empty, each of data of SU_{Nj}, data of SU_{N2}, and data of SU_{N3} includes the time stamp TP_{N} at which the first client obtains the stripe S_{N}, and data of a check strip SU_{N4} of the stripe S_{N} includes check data TP_{Np} of the time stamp TP_{N}, and none of data strips of the stripe S_{Y} is empty, each of data of SU_{Y1}, data of SU_{Y2}, and data of SU_{Y3} includes the time stamp TP_{Y} at which the first client obtains the stripe S_{Y}, and data of a check strip SU_{Y4} of the stripe S_{Y} includes check data TP_{Yp} of the time stamp TP_{Y}. Therefore, after a storage node storing a data strip is faulty, the distributed block storage system recovers, in a new storage node based on the stripes and the partition view, the data of the strip SU_{Nj} of the stripe S_{N} in the faulty storage node Nⱼ, and recovers the data of the strip SU_{Yj} of the stripe S_{Y} in the faulty storage node Nⱼ. Therefore, a buffer of the new storage node includes the data of the strip SU_{Nj} and the data of SU_{Yj}. The data of SU_{Nj} includes the time stamp TP_{N}, and the data of SU_{Yj} includes the time stamp TP_{Y}. Because both the time stamp TP_{N} and the time stamp TP_{Y} are assigned by the first client or assigned by a same time stamp server, the time stamps may be compared. The new storage node eliminates, from the buffer based on the time stamp TP_{N} and the time stamp TP_{Y}, strip data corresponding to an earlier time. The new storage node may be a storage node obtained by recovering the faulty storage node Nⱼ, or a storage node of a partition in which a newly added stripe is located in the distributed block storage system. In this embodiment of the present disclosure, an example in which the storage node N₁ is faulty is used, and the buffer of the new storage node includes the data of the strip SU_{N1} and the data of SU_{Y1}. The data of SU_{N1} includes the time stamp TP_{N}, the data of SU_{Y1} includes the time stamp TP_{Y}, and the time stamp TP_{N} is earlier than the time stamp TP_{Y}. Therefore, the new storage node eliminates the data of the strip SU_{N1} from the buffer, and reserves latest strip data in the storage system, thereby saving buffer space. The storage node Nⱼ may eliminate, based on time stamps assigned by a same client, strip data, corresponding to an earlier time, in strip data that is from the same client and that has a same logical address in the buffer, and reserve latest strip data, thereby saving buffer space.

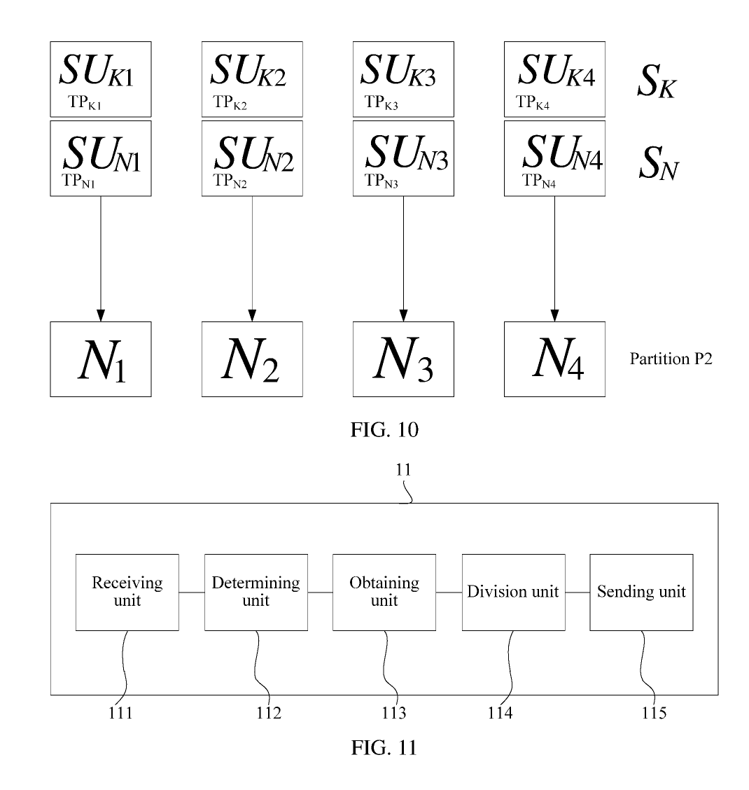

With reference to the embodiment shown in FIG. 6 and the related description, when a logical unit is mounted to the first client and the second client, the storage node Nⱼ assigns a time stamp TP_{Nj} to the data of the strip SU_{Nj} sent by the first client, and the storage node Nⱼ assigns the time stamp TP_{Kj} to the data of the strip SU_{Kj} sent by the second client. As shown in FIG. 10, none of data strips of a stripe S_{N} is empty, a time stamp assigned by a storage node N₁ to data of a strip SU_{N1} is TP_{N1}, a time stamp assigned by a storage node N₂ to data of a strip SU_{N2} is TP_{N2}, a time stamp assigned by a storage node N₃ to data of a strip SU_{N3} is TP_{N3}, and a time stamp assigned by a storage node N₄ to data of a strip SU_{N4} is TP_{N4}, and none of data strips of a stripe S_{K} is empty, a time stamp assigned by the storage node N₁ to data of a strip SU_{K1} is TP_{K1}, a time stamp assigned by the storage node N₂ to data of a strip SU_{K2} is TP_{K2}, a time stamp assigned by the storage node N₃ to data of a strip SU_{K3} is TP_{K3}, and a time stamp assigned by the storage node N₄ to data of a strip SU_{K4} is TP_{K4}. Therefore, after a storage node storing a data strip is faulty, the distributed block storage system recovers, based on the stripes and the partition view, the data of the strip SU_{Nj} of the stripe S_{N} in the faulty storage node Nⱼ, and recovers the data of the strip SU_{Kj} of the stripe S_{K} in the faulty storage node Nⱼ, a buffer of a new storage node includes the data of the strip SU_{Nj} and the data of SU_{Kj}. In an implementation, when the data of the strip SU_{Nj} includes the time stamp TP_{N} assigned by the first client, the data of the strip SU_{Kj} includes the time stamp TP_{K} assigned by the second client, and TP_{N} and TP_{K} are assigned by a same time stamp server, the time stamp TP_{N} of the data of the strip SU_{Nj} may be directly compared with the time stamp TP_{K} of the data of SU_{Kj}, and the new storage node eliminates, from the buffer based on the time stamp TP_{N} and the time stamp TP_{K}, strip data corresponding to an earlier time. When the data of the strip SU_{Nj} does not include the time stamp TP_{N} assigned by the first client and/or the data of the strip SU_{Kj} does not include the time stamp TP_{K} assigned by the second client, or when the time stamps TP_{N} and TP_{K} are not from a same time stamp server, the buffer of the new storage node includes the data of the strip SU_{Nj} and the data of SU_{Kj}. The new storage node may query for time stamps of data of strips of stripes S_{N} and S_{K} in a storage node N_{X}. For example, the new storage node obtains a time stamp TP_{NX} assigned by the storage node N_{X} to data of a strip SU_{NX}, and uses TP_{NX} as a reference time stamp of the data of SU_{Nj}, and the new storage node obtains a time stamp TP_{KX} assigned by the storage node N_{X} to data of a strip SU_{KX}, and uses TP_{KX} as a reference time stamp of the data of SU_{Kj}, and the new storage node eliminates, from the buffer based on the time stamp TP_{NX} and the time stamp TP_{KX}, strip data, corresponding to an earlier time, in the data of the strip SU_{Nj} and the data of SU_{Kj}, where X is any integer from 1 to M other than j. In this embodiment of the present disclosure, an example in which the storage node N₁ is faulty is used, and the buffer of the new storage node includes the data of the strip SU_{N1} and the data of SU_{K1}. The new storage node obtains a time stamp TP_{N2} assigned by the storage node N₂ to the data of SU_{N2} as a reference time stamp of the data of SU_{N1}, and obtains a time stamp TP_{K2} assigned by the storage node N₂ to the data of SU_{K2} as a reference time stamp of the data of SU_{K1}, and the time stamp TP_{N2} is earlier than the time stamp TP_{K2}. Therefore, the new storage node eliminates the data of the strip SU_{N1} from the buffer, and reserves latest strip data in the storage system, thereby saving buffer space. In this embodiment of the present disclosure, the storage node Nⱼ also assigns a time stamp TP_{Yj} to the data of the strip SU_{Yj}.

A time stamp assigned by the storage node Nⱼ may be from a time stamp server, or may be generated by the storage node Nⱼ.

Further, an identifier of the first client included in the data of the data strip SU_{Nj}, a time stamp at which the first client obtains the stripe S_{N}, an identifier of the data strip SU_{Nj}, a logical address of the data of the data strip SU_{Nj}, and data strip status information may be stored at an extension address of a physical address assigned by the storage node Nⱼ to the data strip SU_{Nj}, thereby avoiding use of a physical address of the storage node Nⱼ. The extension address of the physical address is a physical address that is invisible beyond a valid physical address capacity of the storage node Nⱼ, and when receiving a read request for accessing the physical address, the storage node Nⱼ reads data in the extension address of the physical address by default. An identifier of the second client included in the data of the data strip SU_{Kj}, a time stamp at which the second client obtains the stripe S_{K}, an identifier of the data strip SU_{Kj}, a logical address of the data of the data strip SU_{Kj}, and data strip status information may also be stored at an extension address of a physical address assigned by the storage node Nⱼ to the data strip SU_{Kj}. Likewise, an identifier of the first client included in the data strip SU_{Yj}, a time stamp at which the first client obtains the stripe S_{Y}, an identifier of the data strip SU_{Yj}, a logical address of the data of the data strip SU_{Yj}, and data strip status information may also be stored at an extension address of a physical address assigned by the storage node Nⱼ to the data strip SU_{Yj}.

Further, the time stamp TP_{Nj} assigned by the storage node Nⱼ to the data of the strip SU_{Nj} may also be stored at the extension address of the physical address assigned by the storage node Nⱼ to the data strip SU_{Nj}. The time stamp TP_{Kj} assigned by the storage node Nⱼ to the data of the strip SU_{Kj} may also be stored at the extension address of the physical address assigned by the storage node Nⱼ to the data strip SU_{Kj}. The time stamp TP_{Yj} assigned by the storage node Nⱼ to the data of the strip SU_{Yj} may also be stored at the extension address of the physical address assigned by the storage node Nⱼ to the data strip SU_{Yj}.

With reference to various implementations of the embodiments of the present disclosure, an embodiment of the present disclosure provides an apparatus 11 for writing data, applied to a distributed block storage system in the embodiments of the present disclosure. As shown in FIG. 11, the apparatus 11 for writing data includes a receiving unit 111, a determining unit 112, an obtaining unit 113, a division unit 114, and a sending unit 115. The receiving unit 111 is configured to receive a first write request, where the first write request includes first data and a logical address. The determining unit 112 is configured to determine that the logical address is located in a partition P. The obtaining unit 113 is configured to obtain a stripe S_{N} from R stripes, where N is an integer from 1 to R. The division unit 114 is configured to divide the first data into data of one or more strips SU_{Nj} in the stripe S_{N}. The sending unit 115 is configured to send the data of the one or more strips SU_{Nj} to a storage node Nⱼ. Further, the receiving unit 111 is further configured to receive a second write request, where the second write request includes second data and a logical address, and the logical address of the second data is the same as the logical address of the first data. The determining unit 112 is further configured to determine that the logical address is located in the partition P. The obtaining unit 113 is further configured to obtain a stripe S_{Y} from the R stripes, where Y is an integer from 1 to R, and N is different from Y. The division unit 114 is further configured to divide the second data into data of one or more strips SU_{Yj} in the stripe S_{Y}. The sending unit 115 is further configured to send the data of the one or more strips SU_{Yj} to the storage node Nⱼ. For an implementation of the apparatus 11 for writing data in this embodiment of the present disclosure, refer to clients in the embodiments of the present disclosure, such as a first client and a second client. Further, the apparatus 11 for writing data may be a software module, and may be run on a client such that the client completes various implementations described in the embodiments of the present disclosure. Alternatively, the apparatus 11 for writing data may be a hardware device. For details, refer to the structure shown in FIG. 3. Units of the apparatus 11 for writing data may be implemented by the processor of the server described in FIG. 3. Therefore, for a detailed description about the apparatus 11 for writing data, refer to the descriptions of the clients in the embodiments of the present disclosure.

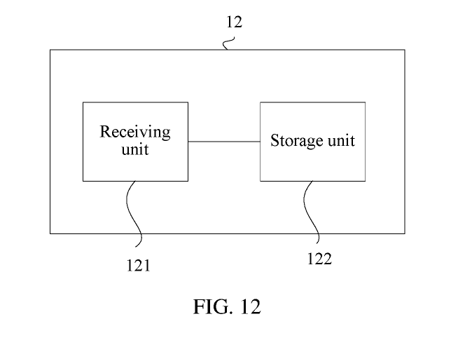

With reference to various implementations of the embodiments of the present disclosure, an embodiment of the present disclosure provides an apparatus 12 for storing data, applied to a distributed block storage system in the embodiments of the present disclosure. As shown in FIG. 12, the apparatus 12 for storing data includes a receiving unit 121 and a storage unit 122. The receiving unit 121 is configured to receive data of a strip SU_{Nj} in a stripe S_{N} sent by a first client, where the data of the strip SU_{Nj} is obtained by dividing first data by the first client, the first data is obtained by receiving a first write request by the first client, the first write request includes first data and a logical address, and the logical address is used to determine that the first data is located in a partition P. The storage unit 122 is configured to store, based on a mapping between an identifier of the strip SU_{Nj} and a first physical address of the storage node Nⱼ, the data of SU_{Nj} at the first physical address.

With reference to FIG. 12, the apparatus 12 for storing data further includes an assignment unit configured to assign a time stamp TP_{Nj} to the data of the strip SU_{Nj}.

Further, with reference to FIG. 12, the apparatus 12 for storing data further includes an establishment unit configured to establish a correspondence between a logical address of the data of the strip SU_{Nj} and the identifier of the strip SU_{Nj}.

Further, with reference to FIG. 12, the receiving unit 121 is further configured to receive data of a strip SU_{Yj} in a stripe S_{Y} sent by the first client, where the data of the strip SU_{Yj} is obtained by dividing second data by the first client, the second data is obtained by receiving a second write request by the first client, the second write request includes second data and a logical address, and the logical address is used to determine that the second data is located in the partition P. The storage unit 122 is further configured to store, based on a mapping between an identifier of a strip SU_{Y} and a second physical address of the storage node Nⱼ, the data of SU_{Yj} at the second physical address. Further, with reference to FIG. 12, the assignment unit is further configured to assign a time stamp TP_{Yj} to the data of the strip SU_{Yj}.

Further, with reference to FIG. 12, the establishment unit is further configured to establish a correspondence between a logical address of the data of the strip SU_{Yj} and an identifier of the strip SU_{Yj}. Further, the data of SU_{Yj} includes at least one of an identifier of the first client and a time stamp TP_{Y} at which the first client obtains the stripe S_{Y}.

Further, with reference to FIG. 12, the receiving unit 121 is further configured to receive data of a strip SU_{Kj} in a stripe S_{K} sent by a second client, where the data of the strip SU_{Kj} is obtained by dividing third data by the second client, the third data is obtained by receiving a third write request by the second client, the third write request includes third data and a logical address, and the logical address is used to determine that the third data is located in the partition P. The storage unit 122 is further configured to store, based on a mapping between an identifier of a strip SU_{Kj} and a third physical address of the storage node Nⱼ, the data of SU_{Kj} at the third physical address. Further, the assignment unit is further configured to assign a time stamp TP_{Kj} to the strip SU_{Kj}. Further, the establishment unit is further configured to establish a correspondence between a logical address of the data of the strip SU_{Kj} and an identifier of the strip SU_{Kj}. Further, the apparatus 12 for storing data further includes a recovery unit configured to after the storage node Nⱼ is faulty, recover the data of the strip SU_{Nj} based on the stripe S_{N} and recover the data of the strip SU_{Kj} based on the stripe S_{K}. The apparatus 12 for storing data further includes an obtaining unit configured to obtain a time stamp TP_{NX} of data of a strip SU_{NX} in a storage node N_{X} as a reference time stamp of the data of the strip SU_{Nj}, and obtain a time stamp TP_{KX} of data of a strip SUᵢₓ in the storage node N_{X} as a reference time stamp of the data of the strip SU_{Kj}. The apparatus 12 for storing data further includes an elimination unit configured to eliminate, from a buffer of the new storage node based on the time stamp TP_{NX} and the time stamp TP_{KX}, strip data, corresponding to an earlier time, in the data of the strip SU_{Nj} and the data of SU_{Kj}, where X is any integer from 1 to M other than j.

For an implementation of the apparatus 12 for storing data in this embodiment of the present disclosure, refer to a storage node in the embodiments of the present disclosure, such as a storage node Nⱼ. Further, the apparatus 12 for storing data may be a software module, and may be run on a server such that the storage node completes various implementations described in the embodiments of the present disclosure. Alternatively, the apparatus 12 for storing data may be a hardware device. For details, refer to the structure shown in FIG. 3. Units of the apparatus 12 for storing data may be implemented by the processor of the server described in FIG. 3. Therefore, for a detailed description about the apparatus 12 for storing data, refer to the description of the storage node in the embodiments of the present disclosure.

In this embodiment of the present disclosure, in addition to a stripe generated based on an EC algorithm described above, the stripe may be a stripe generated based on a multi-copy algorithm. When the stripe is a stripe generated based on the EC algorithm, the strips SUᵢⱼ in the stripe include a data strip and a check strip. When the stripe is a stripe generated based on the multi-copy algorithm, all the strips SUᵢⱼ in the stripe are data strips, and the strips SUᵢⱼ have same data.

Correspondingly, an embodiment of the present disclosure further provides a computer readable storage medium and a computer program product, and the computer readable storage medium and the computer program product include a computer instruction used to implement various solutions described in the embodiments of the present disclosure.

In the several embodiments provided in the present disclosure, it should be understood that the disclosed apparatus and method may be implemented in other manners. For example, the unit division in the described apparatus embodiment is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions in the embodiments.

In addition, functional units in the embodiments of the present disclosure may be integrated into one processing unit, or each of the units may exist alone physically, or two or more units are integrated into one unit.

What is claimed is:

1. A method for storing data in a distributed block storage system comprising a partition (P), the P comprising M storage nodes and R stripes, each stripe comprising strips (SUᵢⱼ), j comprising every integer from 1 to M, i comprising every integer from 1 to R, and the method comprising:
receiving, by a storage node (Nⱼ), data of a strip (SU_{Nj}) in a stripe (S_{N}) from a first client, the data of the SU_{Nj} being obtained by dividing first data by the first client, the first data being obtained by receiving a first write request by the first client, the first write request comprising the first data and a logical address, and the logical address determining whether the first data is located in the P; and
storing, by the Nⱼ based on a mapping between an identifier of the SU_{Nj} and a first physical address of the Nⱼ, the data of the SU_{Nj} at the first physical address.

2. The method of claim 1, further comprising assigning, by the Nⱼ, a time stamp (TP_{Nj}) to the data of the SU_{Nj}.

3. The method of claim 1, further comprising establishing, by the Nⱼ, a correspondence between a logical address of the data of the SU_{Nj} and the identifier of the SU_{Nj}.

4. The method of claim 1, wherein the data of the SU_{Nj} comprises at least one of an identifier of the first client or a time stamp (TP_{N}) at which the first client obtains the S_{N}.

5. The method of claim 1, further comprising:
receiving, by the Nⱼ, data of a strip (SU_{Yj}) in another stripe (S_{Y}) from the first client, the data of the SU_{Yj} being obtained by dividing second data by the first client, the second data being obtained by receiving a second write request by the first client, the second write request comprising the second data and the logical address, and the logical address determining whether the second data is located in the P; and
storing, by the Nⱼ based on a mapping between an identifier of the SU_{Yj} and a second physical address of the Nⱼ, the data of the SU_{Yj} at the second physical address.

6. The method of claim 5, further comprising assigning, by the Nⱼ, a time stamp (TP_{Yj}) to the data of the SU_{Yj}.

7. The method of claim 6, further comprising establishing, by the Nⱼ, a correspondence between a logical address of the data of the SU_{Yj} and the identifier of the SU_{Yj}.

8. The method of claim 7, wherein the data of the SU_{Yj} comprises at least one of an identifier of the first client or a time stamp (TP_{Y}) at which the first client obtains the S_{Y}.

9. The method of claim 1, further comprising:
receiving, by the Nⱼ, data of a strip (SU_{Kj}) in another stripe (S_{K}) from a second client, the data of the SU_{Kj} being obtained by dividing third data by the second client, the third data being obtained by receiving a third write request by the second client, the third write request comprising the third data and the logical address, and the logical address determining whether the third data is located in the P; and
storing, by the Nⱼ based on a mapping between an identifier of the SU_{Kj} and a third physical address of the Nⱼ, the data of the SU_{Kj} at the third physical address.

10. The method of claim 1, wherein a strip (SUᵢⱼ) in another stripe (Sᵢ) is assigned by a stripe metadata server from the Nⱼ based on a mapping between the P and the Nⱼ comprised in the P.

11. The method of claim 1, wherein each piece of data of one or more strips further comprises data strip status information, and the data strip status information identifying whether each data strip of a stripe is empty.

12. The method of claim 9, further comprising assigning, by the Nⱼ, a time stamp (TP_{Kj}) to the data of the SU_{Kj}.

13. The method of claim 12, further comprising:
recovering, by a new storage node, the data of the SU_{Nj} based on the S_{N} and the data of the SU_{Kj} based on the S_{K} after the Nⱼ becomes faulty;
obtaining, by the new storage node, a time stamp (TP_{N}x) of data of a strip (SU_{NX}) in another storage node (N_{X}) as a reference time stamp of the data of the SU_{Nj} and a time stamp (TP_{KX}) of data of a strip (SU_{KX}) in the N_{X} as a reference time stamp of the data of the SU_{Kj}; and
eliminating, by the new storage node, from a buffer based on the TP_{NX} and the TP_{KX}, strip data, corresponding to an earlier time, in the data of the SU_{Nj} and the data of the SU_{Kj}, X comprising any integer from 1 to M other than j.

14. A storage node, applied to a distributed block storage system comprising a partition (P), the P comprising M storage nodes and R stripes, each stripe comprising strips (SUᵢⱼ), j comprising every integer from 1 to M, i comprising every integer from 1 to R, and the storage node comprising:
an interface; and
a processor coupled to the interface to communicate with the interface and configured to:
receive data of a strip (SU_{Nj}) in a stripe (S_{N}) from a first client, the data of the SU_{Nj} being obtained by dividing first data by the first client, the first data being obtained by receiving a first write request by the first client, the first write request comprising the first data and a logical address, and the logical address determining whether the first data is located in the P; and
store, based on a mapping between an identifier of the SU_{Nj} and a first physical address of the Nⱼ, the data of the SU_{Nj} at the first physical address.

15. The storage node of claim 14, wherein the processor is further configured to assign a time stamp (TP_{Nj}) to the data of the SU_{Nj}.

16. The storage node of claim 14, wherein the processor is further configured to:
receive data of a strip (SU_{Yj}) in another stripe (S_{Y}) from the first client, the data of the SU_{Yj} being obtained by dividing second data by the first client, the second data being obtained by receiving a second write request by the first client, the second write request comprising the second data and the logical address, and the logical address determining whether the second data is located in the P; and
store, based on a mapping between an identifier of the SU_{Yj} and a second physical address of the Nⱼ, the data of the SU_{Yj} at the second physical address.

17. The storage node of claim 14, wherein the processor is further configured to:
receive data of a strip (SU_{Kj}) in another stripe (S_{K}) from a second client, the data of the SU_{Kj} being obtained by dividing third data by the second client, the third data being obtained by receiving a third write request by the second client, the third write request comprising the third data and the logical address, and the logical address determining whether the third data is located in the P; and
store, based on a mapping between an identifier of the SU_{Kj} and a third physical address of the Nⱼ, the data of the SU_{Kj} at the third physical address.

18. The storage node of claim 14, wherein a strip (SUᵢⱼ) in another stripe (Sᵢ) is assigned by a stripe metadata server from the Nⱼ based on a mapping between the P and the Nⱼ comprised in the P.

19. The storage node of claim 14, wherein each piece of data of one or more strips further comprises data strip status information, and the data strip status information identifying whether each data strip of a stripe is empty.

20. A computer readable storage medium, comprising a computer instruction applied to a distributed block storage system comprising a partition (P), the P comprising M storage nodes and R stripes, each stripe comprises strips (SUᵢⱼ), j comprising every integer from 1 to M, i comprising every integer from 1 to R, and the computer readable storage medium further comprising a first computer instruction to enable a storage node (Nⱼ) to perform the following operations of:
receiving data of a strip (SU_{Nj}) in a stripe (S_{N}) from a first client, the data of the SU_{Nj} being obtained by dividing first data by the first client, the first data being obtained by receiving a first write request by the first client, the first write request comprising the first data and a logical address, and the logical address determining whether the first data is located in the P; and
storing, based on a mapping between an identifier of the SU_{Nj} and a first physical address of the Nⱼ, the data of the SU_{Nj} at the first physical address.

21. The computer readable storage medium of claim 20, further comprising a second computer instruction to enable the Nⱼ to perform the following operations of:
receiving data of a strip (SU_{Kj}) in another stripe (S_{K}) from a second client, the data of the SU_{Kj} being obtained by dividing second data by the second client, the second data being obtained by receiving a second write request by the second client, the second write request comprising the second data and the logical address, and the logical address determining whether the second data is located in the P; and
storing, based on a mapping between an identifier of the SU_{Kj} and a second physical address of the Nⱼ, the data of the SU_{Kj} at the second physical address.

22. The computer readable storage medium of claim 21, further comprising a third computer instruction to enable the Nⱼ to perform the following operation of assigning a time stamp (TP_{Kj}) to the data of the SU_{Kj}.

23. The computer readable storage medium of claim 22, wherein in response to the storage node Nⱼ is faulty, a fourth computer instruction enables a new storage node to perform the following operations of:
recovering the data of the SU_{Nj} based on the S_{N} and the data of the SU_{Kj} based on the S_{K};
obtaining a time stamp (TP_{NX}) of data of a strip (SU_{NX}) in another storage node (N_{X}) as a reference time stamp of the data of the SU_{Nj} and a time stamp (TP_{KX}) of data of a strip (SU_{KX}) in the N_{X} as a reference time stamp of the data of the SU_{Kj}; and
eliminating, from a buffer of the new storage node based on the TP_{NX} and the TP_{KX}, strip data, corresponding to an earlier time, in the data of the SU_{Nj} and the data of the SU_{Kj}, X comprising any integer from 1 to M other than j.
